(19) United States
(12) Patent Application Publication
(10) Pub. No.: US 2021/0276763 A1
(43) Pub. Date: Sep. 9, 2021

(54) PET Bottle for Efficient Recycling Comprising an Easily Removable Label and a Cap without a Retainer Ring

(71) Applicant: DONGIL CHEMICAL CO., LTD., Cheonan-si (KR)

(72) Inventor: Won Suk OH, Yongin-si (KR)

(21) Appl. No.: 16/921,751

(22) Filed: Jul. 6, 2020

(30) Foreign Application Priority Data
Mar. 6, 2020 (KR) 10-2020-0028096

(51) Int. Cl. B65D 23/08; B08B 9/08; G09F 3/04

(52) U.S. Cl. CPC B65D 23/0878; B29L 2031/744; G09F 3/04; B08B 9/083

(57) ABSTRACT

The present invention relates to a PET bottle which increases recycling rate of PET bottles, wherein the PET bottle comprises a label that assembles the cap 20 without a retainer ring 21 on to the body 10 of the PET bottle, seals from the top of the cap 20 to the upper portion of the body 10 with the one continuous label and safety seal film 50, and has vertical parallel perforated lines 51 on one portion of the sealed label and safety seal film 50. A flap 52 extends from the end of the upper end of the perforated lines 51 to assist with tearing the label. The sealed label and safety seal film 50 covers the upper portion of the body 10 in shape of an inverted funnel, such that when it is torn along the perforated lines 51, the film 50 will be separated naturally from the bottle.

### TECHNICAL FIELD

The present invention relates to various PET (polyester) bottles for holding varieties of liquid content such as drinking water, beverages and so on. More specifically, the present invention relates to a PET bottle which comprises a label that is easily removed as the cap of the PET bottle is opened.

### BACKGROUND ART

PET bottles made from polyester (PET) are used as various containers that are essential in our daily lives today. Since most of the PET bottles are thrown away after single use, collecting and recycling used bottles are very important, not only in terms of protecting the environment, but also in terms of saving resources.

The worldwide recycling rate of PET bottles is about 60%, and the remaining 40% of PET resources are discarded. Discarded PET bottles are becoming main culprit causing environmental pollution. In particular, PET bottles cause serious level of marine pollution, and also adversely affect marine ecology since PET does not decompose for a long time. Most of the remnants flowing into the oceans are PET bottles that have been thrown away instead of being recycled. Considering that PET bottles that are recycled are sold for high price, problems caused by discarded PET bottles will be naturally solved once the bottles can be recycled easily. Increasing the recycling rate of PET bottles is the way to reducing environmental pollution.

There have been many efforts to increase the recycling rate of PET bottles, but a method that can have significant effect is yet to be developed due to various problems. One of the reasons hindering the increase of recycling rate of PET bottles is that the label on the PET bottle and the retainer ring attached to the cap are not easily removable.

The body of a PET bottle is made of polyester, the cap is made of polyethylene (PE) or polypropylene, and the label is typically made of PET, polystyrene (PS), or polypropylene. As such, due to their characteristics, the label and the cap are made of different material as the body. The label in particular is printed in varieties of colors regardless of its material. Therefore, the label and the cap both have to removed beforehand in order to easily recycle the body of the PET bottle.

There are two methods for placing a label on a PET bottle: the thermal contraction method using heat shrink film made of PS or PET, and the adhesion method using glue to attach the label made of PP.

Using the thermal contraction method to place the label on the bottle does not present much problem for removing the label, because in said method, the heat shrink label film shrinks under applied heat and thereby it is placed on the bottle without using glue. Thus, when the PET bottle is cut and grinded, the PET bottle and the label are separated naturally. However, in the adhesion method using glue to adhere the label made of PP, the label is adhered to the body of the PET bottle by melting hot melt adhesive or using adhesive dissolved in solvent, therefore the label cannot be easily removed from the bottle in this method.

Most of the PET bottles such as water bottles utilize method of adhering PP film label to the bottle with adhesive because the process is simpler and the cost is cheaper compared to those of thermal contraction method.

In order to remove the label that has been attached using adhesive from the PET bottle, people have to remove them one by one manually. This removal process cannot be done solely by hand; it requires tools such as sharp knives. If everyone discarding PET bottles in recycle bins use their own tools such as knives to remove the label from all the bottles, the problem caused by labels will be solved instantly and recycling rate will increase. However, in practice, due to this inconvenience, the bottles are discarded with the labels still attached to them.

Various technologies have been developed from numerous studies on methods for removing the label from the PET bottles. Korean Patent No. 10-0180891 discloses label stripper for easily removing the label on the surface of the PET bottle and method of label removal using the label stripper for recycling PET bottles. Korean Patent Application Publication No. 10-1999-0083998, Korean Patent No. 10-0875241, and Korean Patent No. 10-1611928 disclose device for removing labels of PET bottles. However, the label removal devices of aforementioned patents have complex structures and are expensive, such that they were not efficient solution for removing labels from PET bottles in wide scale, and therefore did not achieve commercial success.

The inventor of present invention has developed and filed a patent application (Korean Patent Application No. 10-2019-54873, filed on May 10, 2019) for a novel PET bottle from which label can be easily removed, wherein the bottle provides new ideas for simple label removal by hand without need for separate tools such as huge label removal devices or knives, and can be implemented by any individual to remove the labels themselves.

Even if the label is removed from the PET bottle, another problem still remains in that the retainer ring, which has been detached from the cap, also has to be removed.

FIG. 1 is an illustration of a conventional PET bottle for beverage, wherein the PET bottle comprises a body 10 made of PET, a cap 20 made of PP or PE, and a label 30 made of mixed materials formed to wrap around the body. As seen on FIG. 1B, when the cap 20 is twisted opened, a retainer ring 21 which was attached at the bottom is detached from the cap and remains on the body 10 of the PET bottle.

This retainer ring 21 is formed as an integral part of the cap 20 for the purpose of safety seal, but once the cap 20 is opened, it is detached from the cap 20 and remains on the body 10 of the PET bottle. In order to recycle the PET bottle, the retainer ring 21 has to be removed, but the removal process for this retainer ring 21 is not simple. The retainer ring 21 cannot be removed by hand, and requires cutting tools such as knives.

Korean Utility Model Application Publication No. 20-2000-0003422 discloses PET bottle cap removal device which turns PET bottles into readily recyclable chips by going through PET bottle cap removal process, label and base cup removal process, bottleneck removal process, ring removal process, crushing process and so on. However, it is impractical for actual application.

Removing labels from conventional PET bottles is not simple as well. As seen on FIG. 1B, vertical parallel perforated lines 31 are placed for removing the label 30, but most of the consumers do not take time to tear off the label 30 using these perforated lines. Sometimes, even when one attempts to tear the label along the perforated lines 31, the material properties of the label film may not allow for vertical cut and make the label removal difficult.

In order to solve the problem of the retainer ring 21 of the cap 20 remaining on the body 10, cap 20 without retainer ring 21 has been developed. In this case, safety seal becomes another problem. Therefore, in this case, safety seal film 40 is designed to cover and seal the cap 20 in its entirety.

FIG. 2 is a perspective view of a PET bottle in which the cap 20 does not have a retainer ring and the safety seal film 40 covers and seals the cap 20 entirely. As seen on FIG. 2A, the safety seal film 40 is used to seal entire cap 20 which does not have a retainer ring, and the safety seal film 40 has vertical parallel perforated lines 41. The cap 20 can be opened after the safety seal film 40 is torn downwards along the perforated lines 41. While the problem involving the retainer ring is resolved for the PET bottle of FIG. 2 since it does not have a retainer ring, the problem of having to remove the label 30 from the body of the bottle still remains.

The inventor has come to invent present invention of novel PET bottle which simultaneously solves problems cause by both the label on the PET bottle and the retainer ring attached on the cap. Therefore, it does not require extra efforts for removing the label and the retainer ring from the PET bottle and as such, almost all the PET bottles become recyclable.

### SUMMARY OF THE INVENTION

### Technical Problem

The purpose of the present invention is to provide a PET bottle that can significantly increase the recycling rate by using the label and safety seal film to seal the cap, which does not have a retainer ring, therefore eliminating the need for removing the retainer ring separately.

Another purpose of the present invention is to provide safety of the product by sealing the cap, which does not have a retainer ring, using the label and safety seal film, and simultaneously provide a PET bottle that can increase the recycling rate by eliminating the need for removing the label separately.

Further purpose of the present invention is to provide a PET bottle that can ultimately reduce pollution of the natural ecosystem by increasing the recycling rate of PET bottles that will lead to saving resources and reducing waste.

Yet another purpose of the present invention is to provide a PET bottle that does not require the label to be adhered on to the body of PET bottle.

The aforementioned and other purposes of present invention can be achieved by the present invention described in more detail below.

### Solution to Problem

The PET bottle which increases recycling rate of PET bottles according to present invention comprises a label that assembles the cap 20 without a retainer ring 21 on to the body 10 of the PET bottle, seals from the top of the cap 20 to the upper portion of the body 10 with the one continuous label and safety seal film 50, and has vertical parallel perforated lines 51 on one portion of the sealed label and safety seal film 50. A flap 52 extends from the end of the upper end of the perforated lines 51 to assist with tearing the label.

Since the sealed label and safety seal film 50 covers the upper portion of the body 10 in shape of a funnel, as it is torn along the perforated lines 51, the film 50 will be separated naturally from the bottle. Because the cap 20 does not have a retainer ring, when the film 50 is removed by tearing it along the perforated lines 51, and then the cap 20 is taken off, only the body 10 of the PET bottles remains. Therefore, without having to remove the retainer ring or the label separately, the body 10 of the PET bottle is naturally separated from other components.

Since the cap 20 is made of polyethylene (PE) or polypropylene (PP), and the label and safety seal film 50 is made of polystyrene (PS), PET, or polypropylene (PP), these two components can be easily removed from the body 10 of the PET bottle.

The label and safety seal film 50 not only acts as a safety seal by completely sealing the cap, but also acts as the label by having various kinds of information regarding the product (e.g. trademark) printed on upper inclined surface of the film.

The PET bottle of present invention does not require a label to be adhered on its body, and uses a label with significantly less surface area compared to conventional PET bottles, therefore it reduces amount of shrink film used as the label and can contribute to cost reduction.

The present invention is described in greater detail below, with reference to the appended drawings.

### Advantageous Effects of Invention

The present invention has advantageous effects of providing a novel PET bottles which eliminates need for removing retainer ring from the bottle by using with the label and safety seal film to seal the cap, which does not have a retainer ring, ensures safety of the product by using the label and safety seal film to seal the cap, which does not have a retainer ring, and at the same time, eliminates need for removing the label separately, saves resources by increasing recycling rate of PET bottles, reduces wastes, and ultimately, reduces natural ecosystem pollution.

### BRIEF DESCRIPTION OF DRAWINGS

FIG. 1 depicts perspective view of a conventional PET bottle for beverage, wherein (A) is a perspective view with an unopened cap 20, and (B) is a perspective view with the cap 20 opened.

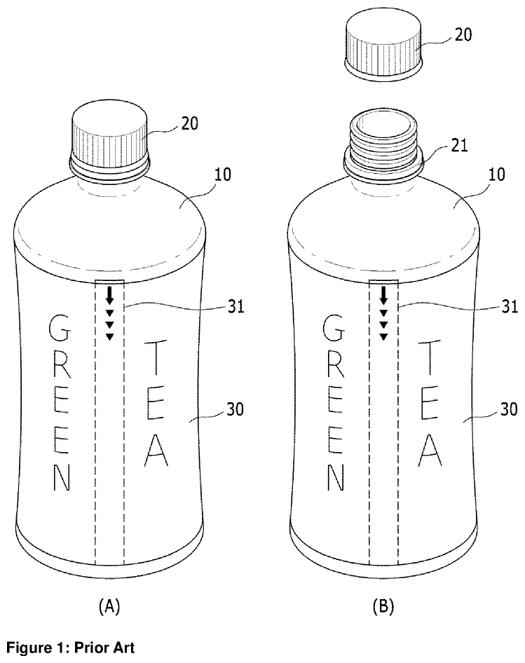

FIG. 2 depicts perspective view of PET bottle in which the conventional cap 20 without a retainer ring is completely sealed with the safety seal film 40, wherein (A) is a perspective view with the safety seal film 40 on the bottle, and (B) is a perspective view with the safety seal film 40 removed and the cap 20 opened.

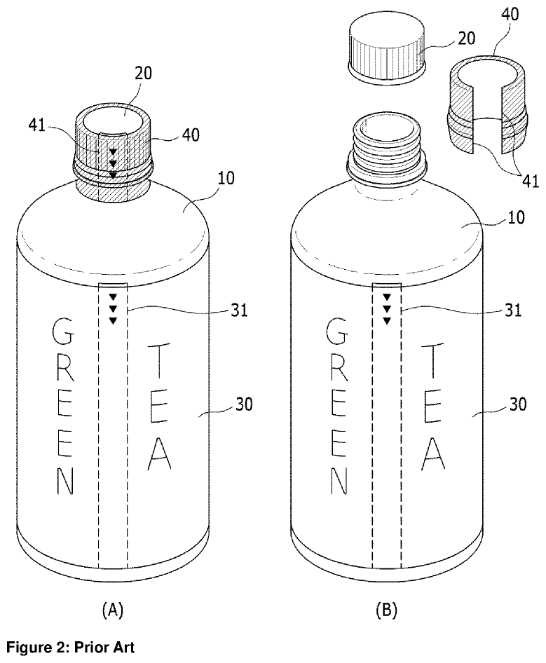

FIG. 3 depicts perspective view of PET bottle in which the entire cap 20, without a retainer ring, is sealed with the label and safety seal film 50, wherein (A) is a perspective view with the label and safety seal film 40 still on the bottle, and (B) is a perspective view with the label and safety seal film 40 removed and the cap 20 opened.

### DETAILED DESCRIPTION

The present invention relates to various PET (polyester) bottles for holding varieties of liquid content such as drinking water, beverages and such, wherein the PET bottle can significantly increase the recycling rate by having a label that is easily removable as the cap of the PET bottle is opened.

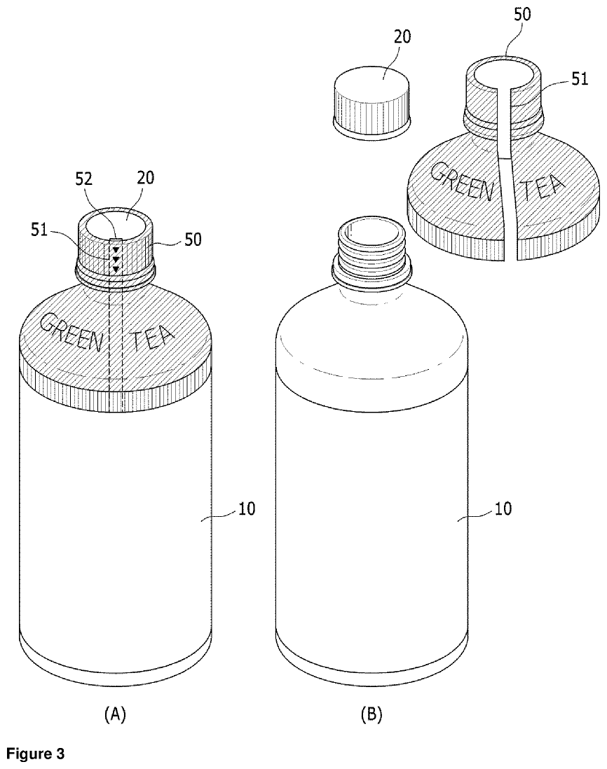

FIG. 3 is perspective view of PET bottle in which the entire cap 20, without a retainer ring, is sealed with the label and safety seal film 50, wherein (A) is a perspective view with the label and safety seal film 50 still on the bottle, and (B) is a perspective view with the label and safety seal film 50 removed and the cap 20 opened.

The PET bottle which increases recycling rate of PET bottles according to present invention comprises a label that assembles the cap 20 without a retainer ring 21 on to the body 10 of the PET bottle, seals from the top of the cap 20 to the upper portion of the body 10 with the one continuous label and safety seal film 50, and has vertical parallel perforated lines 51 on one portion of the sealed label and safety seal film 50. A flap 52 extends from the end of the upper end of the perforated lines 51 to assist with tearing the label. The label can be easily torn by pulling the flap 52 in vertical direction along the perforated lines 51.

Since the sealed label and safety seal film 50 covers the upper portion of the body 10 in shape of an inverted funnel, as it is torn along the perforated lines 51, the film 50 will be separated naturally from the bottle. The length of the film 50 extending vertically from the inverted funnel is preferably, but not limited to, 0.5˜3.0 cm.

Because the cap 20 does not have a retainer ring, when the film 50 is removed by tearing it along the perforated lines 51, and the cap 20 is taken off, only the body 10 of the PET bottles remains. Therefore, without having to remove the retainer ring or the label separately, the body 10 of the PET bottle is naturally separated from other components.

As the cap 20 is made of polyethylene (PE) or polypropylene (PP), and the label and safety seal film 50 is made of polystyrene (PS), PET, or polypropylene (PP), these two components can be easily removed from the body 10 of the PET bottle. The inventor of present invention has developed a shrink film used for the label and was granted following patents: Korean Patent No. 10-926716, No. 10-1156607, and No. 10-1486799.

Preferably, these films are used as the label and safety seal film 50.

The label and safety seal film 50 not only acts as a safety seal by completely sealing the cap 20, but also acts as a label by having various kinds of information regarding the product (e.g. manufacturer, reseller, phone number etc.) printed on its upper inclined surface.

The PET bottle of present invention does not require a label to be adhered on its body, and uses a label with significantly less surface area compared to conventional PET bottles. Therefore, it reduces amount of shrink film used as the label and can contribute to cost reduction.

The present invention ensures safety of the product by sealing the cap, which does not have a retainer ring, with the label and safety seal film, and at the same time, provides a novel label for PET bottles which eliminates need for removing the label separately, and increases recycling rate of PET bottles.

The present invention may be put into practice with simple modifications and variations by persons skilled in the art, and such modifications and variation are all within the scope of the present invention.

### REFERENCE NUMERALS

10: PET bottle body
20: Cap
21: Retainer ring
30: Label
31: Perforated lines
40: Safety seal film
41: Perforated lines
50: Label and safety seal film
51: Perforated lines
52: Flap

1. A PET bottle for efficient recycling of the PET bottle by allowing easy removal of cap and label, wherein the PET bottle comprises:
a body 10 of PET bottle;
a cap 20 closed on the top of the body 10 of the bottle, wherein the cap 20 does not have a retainer ring; and
a label and safety seal film 50 covering from top of the cap 20 to the upper part of the body 10 of the bottle, wherein the film 50 has a flap 52 with vertical parallel perforated lines 51 for removing the film 50.

2. The PET bottle as claimed in claim 1, wherein the flap 52 extends in upwardly from the film 50.

3. The PET bottle as claimed in claim 2, wherein the vertical parallel perforated lines 51 are formed from top to bottom of the film 50, thereby the whole film 50 is removed from the body 10 of the bottle when the flap 52 is torn off.

4. The PET bottle as claimed in claim 3, wherein the upper part of the bottle includes a neck and the body 10 having a height of about 0.5 to about 5.0 cm.

5. The PET bottle as claimed in claim 1, wherein the film 50 is a shrink film, and functions as a safety seal for sealing the cap and as a label in which necessary information is printed.
